(19) United States
(12) Patent Application Publication
(10) Pub. No.: US 2024/0303032 A1
(43) Pub. Date: Sep. 12, 2024

(54) CONTROL DEVICE, CONTENT VIEWING CONTROL SYSTEM, MOVING OBJECT, CONTROL METHOD, AND COMPUTER-READABLE STORAGE MEDIUM

(71) Applicant: HONDA MOTOR CO.,LTD., Tokyo (JP)

(72) Inventors: Takashi NOGUCHI, Tokyo (JP); Ryosuke TANAKA, Tokyo (JP); Shinichi KIKUCHI, Tokyo (JP)

(21) Appl. No.: 18/595,425

(22) Filed: Mar. 5, 2024

(30) Foreign Application Priority Data
Mar. 9, 2023 (JP) 2023-036809

(51) Int. Cl. G06F 3/16; G06F 3/01; G06F 3/14

(52) U.S. Cl. CPC G06F 3/165; G06F 3/013; G06F 3/14

(57) ABSTRACT

Provided is a control device for a display device installed on the moving object. The display device includes a first display mode in which content is displayed without dividing a display region, and a second display mode in which the display region is divided into a first display region for a first seat installed in the moving object and a second display region for a second seat within the moving object for displaying. The control device includes an obtaining module which obtains information indicating a display mode of the display device; and a control module which performs zoning of a space within the moving object to output audio, wherein the control module differentiates the zoning depending on whether the display mode of the display device is the first display mode or the second display mode.

The contents of the following Japanese patent application(s) are incorporated herein by reference:
NO. 2023-036809 filed in JP on Mar. 9, 2023.

### BACKGROUND

### 1. Technical Field

The present invention relates to a control device, a content viewing control system, a moving object, a control method, and a computer-readable storage medium.

### 2. Related Art

Patent document 1 and Patent document 2 describe dividing a screen to display a plurality of videos and controlling a sound output according to the display position of the moving image.

### CITATION LIST

### Patent Document

Patent Document 1: Japanese Patent Application Publication No. 2013-187841
Patent Document 2: Japanese Patent Application Publication No. 2005-110103

### BRIEF DESCRIPTION OF THE DRAWINGS

FIG. 1 conceptually shows a configuration of a moving object 10 according to an embodiment.

FIG. 2 shows an example of a configuration of a content viewing control system 200 included in the moving object 10.

FIG. 3 schematically shows a display region of a display device 22.

FIG. 4 schematically shows a zone 400 when a display mode of the display device 22 is a first display mode.

FIG. 5 schematically shows a first zone 510 and a second zone 520 when the display mode of the display device 22 is switched to a second display mode.

FIG. 6 schematically shows, as another aspect, a zone 600 when the display modes of the display device 22 and the display device 24 are the first display mode.

FIG. 7 schematically shows the first zone 510, the second zone 520, a first zone 710, and a second zone 720 when the display modes of the display device 22 and the display device 24 are switched to the second display mode.

FIG. 8 shows a flowchart according to a control method performed by a control module 220.

FIG. 9 shows an example of a computer 2000.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are essential to the solution of the invention.

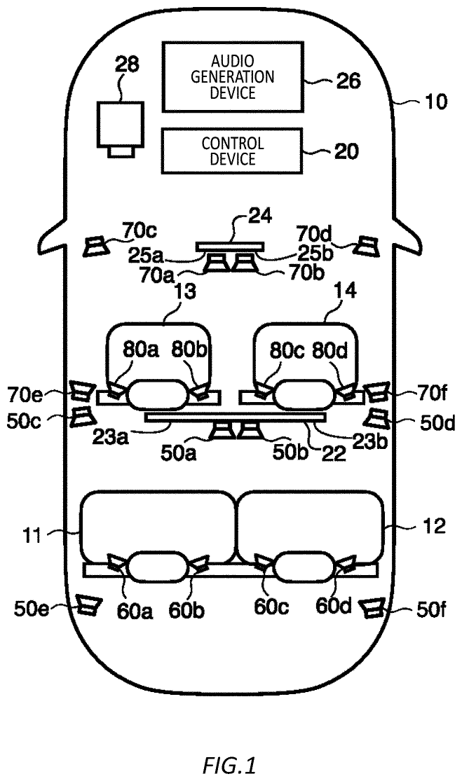

FIG. 1 conceptually shows a configuration of a moving object 10 according to an embodiment. In the present embodiment, the moving object 10 is a vehicle.

The moving object 10 includes a control device 20; an audio generation device 26; a display device 22 and a display device 24; a speaker 50a, a speaker 50b, a speaker 50c, a speaker 50d, a speaker 50e, and a speaker 50f; a speaker 60a, a speaker 60b, a speaker 60c, and a speaker 60d; a speaker 70a, a speaker 70b, a speaker 70c, a speaker 70d, a speaker 70e, and a speaker 70f; a speaker 80a, a speaker 80b, a speaker 80c, and a speaker 80d; a first seat 11, a second seat 12, a first seat 13 and a second seat 14; and an image-capturing device 28.

The first seat 11 and the second seat 12 are the back seats of the moving object 10. The first seat 11 is a seat located on the left side of the forward-moving direction of the moving object 10. The second seat 12 is a seat located on the right side of the forward-moving direction of the moving object 10. The first seat 13 and the second seat 14 are the front seats of the moving object 10. The first seat 13 is a seat located on the left side of the forward-moving direction of the moving object 10. The second seat 14 is a seat located on the right side of the forward-moving direction of the moving object 10.

In the present embodiment, the speaker 50a, the speaker 50b, the speaker 50c, the speaker 50d, the speaker 50e, and the speaker 50f may be collectively referred to as a “speaker 50”, and the speaker 60a, the speaker 60b, the speaker 60c, and the speaker 60d may be collectively referred to as a “speaker 60”. Similarly, the speaker 70a, the speaker 70b, the speaker 70c, the speaker 70d, the speaker 70e, and the speaker 70f may be collectively referred to as a “speaker 70”, and the speaker 80a, the speaker 80b, the speaker 80c, and the speaker 80d may be collectively referred to as a “speaker 80”.

The speaker 50 and the speaker 70 constitute a multi-channel, such as 5.1 channel and 7.1 channel, speaker system. The speaker 50 is a speaker mainly for providing occupants sitting in the first seat 11 and the second seat 12 with audio content. The speaker 70 is a speaker mainly for providing occupants sitting in the first seat 13 and the second seat 14 with audio content. The speaker 60a and the speaker 60b are disposed on a headrest of the first seat 11. The speaker 60a and the speaker 60b are speakers mainly for providing an occupant sitting in the first seat 11 with audio content. The speaker 60c and the speaker 60d are disposed on a headrest of the second seat 12. The speaker 60c and the speaker 60d are speakers mainly for providing an occupant sitting in the second seat 12 with audio content. The speaker 80a and the speaker 80b are disposed on a headrest of the first seat 13. The speaker 80a and the speaker 80b are speakers mainly for providing an occupant sitting in the first seat 13 with audio content. The speaker 80c and the speaker 80d are disposed on a headrest of the second seat 14. The speaker 80c and the speaker 80d are speakers mainly for providing an occupant sitting in the second seat 14 with audio content.

A case is now described where an occupant sitting in a back seat views content by using the display device 22, the speaker 50, and the speaker 60. The display device 22 displays content. For example, the display device 22 displays video content or image content. The speaker 50 and the speaker 60 output audio of audio content associated with the content displayed by the display device 22. Specifically, the audio generation device 26, based on audio data associated with the content displayed by the display device 22, generates an audio signal to be output to the speaker 50 and the speaker 60. The speaker 50 and the speaker 60 output audio based on the audio signal output by the audio generation device 26. The occupant sitting in the first seat 11 and the occupant sitting in the second seat 12 can view the content displayed by the display device 22, and listen to the audio output by the speaker 50 and the speaker 60.

The control device 20 controls the content displayed by the display device 22. The display device 22 includes a first display mode in which single content is displayed on the entire display region, as well as a plurality of display modes including a second display mode in which the entire display region is divided into a plurality of display regions for displaying. For example, the display device 22 can display first content on a first display region 23a on the left side of the forward-moving direction of the moving object 10, and display second content on a second display region 23b on the right side of the forward-moving direction of the moving object 10. When the display mode of the display device 22 is the first display mode, the control device 20 performs zoning of a back seat space within the moving object 10 into one zone to output audio content. Specifically, the control device 20 causes the speaker 50 to output the audio content.

On the other hand, when the display mode of the display device 22 is the second display mode, the control device 20 performs zoning of the back seat space within the moving object 10 into a first zone corresponding to the position of the first seat 11 and a second zone corresponding to the position of the second seat 12 to output first audio content associated with the first content to the first zone, and output second audio content associated with the second content to the second zone. Specifically, the control device 20 causes the speaker 60a and the speaker 60b to output the first audio content, and causes the speaker 60c and the speaker 60d to output the second audio content. At this time, the control device 20 causes the speaker 60a and the speaker 60b to output a sound wave of the first audio content, as well as a sound wave having the substantially opposite phase to a sound wave of the second audio content output from the speaker 60c and the speaker 60d. This allows the occupant sitting in the first seat 11 to listen to substantially only the first audio content. Similarly, the control device 20 causes the speaker 60c and the speaker 60d to output a sound wave of the second audio content, as well as a sound wave having the substantially opposite phase to a sound wave of the first audio content output from the speaker 60a and the speaker 60b. This allows the occupant sitting in the second seat 12 to listen to substantially only the second audio content.

The occupants sitting in the front seats, when they view content by using the display device 24, the speaker 70, and the speaker 80, conduct operations similar to those when they view content by using the display device 22, the speaker 50, and the speaker 60 as mentioned above. That is, similar to the display device 22, the display device 24 includes a plurality of display modes including the first display mode and the second display mode. When the display mode of the display device 24 is the first display mode, the control device 20 sets a front seat space within the moving object 10 as one zone to output audio content in accordance with the set zone. Specifically, the control device 20 causes the speaker 70 to output the audio content.

On the other hand, when the display mode of the display device 24 is the second display mode, the display device 24 displays first content on the first display region 25a and displays second content on the second display region 25b. At this time, the control device 20 sets to the front seat space within the moving object 10 a first zone corresponding to the position of the first seat 13 and a second zone corresponding to the position of the second seat 14 to output first audio content associated with the first content to the first zone, and output second audio content associated with the second content to the second zone. Specifically, the control device 20 causes the speaker 80a and the speaker 80b to output the first audio content, and causes the speaker 80c and the speaker 80d to output the second audio content. At this time, the control device 20 causes the speaker 80a and the speaker 80b to output a sound wave of the first audio content, as well as a sound wave having the substantially opposite phase to a sound wave of the second audio content output from the speaker 80c and the speaker 80d. This allows the occupant sitting in the first seat 11 to listen to substantially only the first audio content. Similarly, the control device 20 causes the speaker 80c and the speaker 80d to output a sound wave of the second audio content, as well as a sound wave having the substantially opposite phase to a sound wave of the first audio content output from the speaker 80a and the speaker 80b. This allows the occupant sitting in the second seat 12 to listen to substantially only the second audio content.

According to the control device 20 described above, for example, when a plurality of occupants sitting in the left and right seats desire to view the same content, the display mode of the display device can be set as the first display mode, and the same zone for at least the entire left and right seats can be set to provide the entire left and right seats with the same content. On the other hand, when the occupants of the left and right seats desire to view mutually different contents, the display mode of the display device can be set as the second display mode, and two zones corresponding to the left and right seats can be set to provide the occupant sitting in one of the seats with one of the audio contents and provide the occupant sitting in the other of the seats with the other of the audio contents. This allows the occupants of the moving object 10 to easily view different contents.

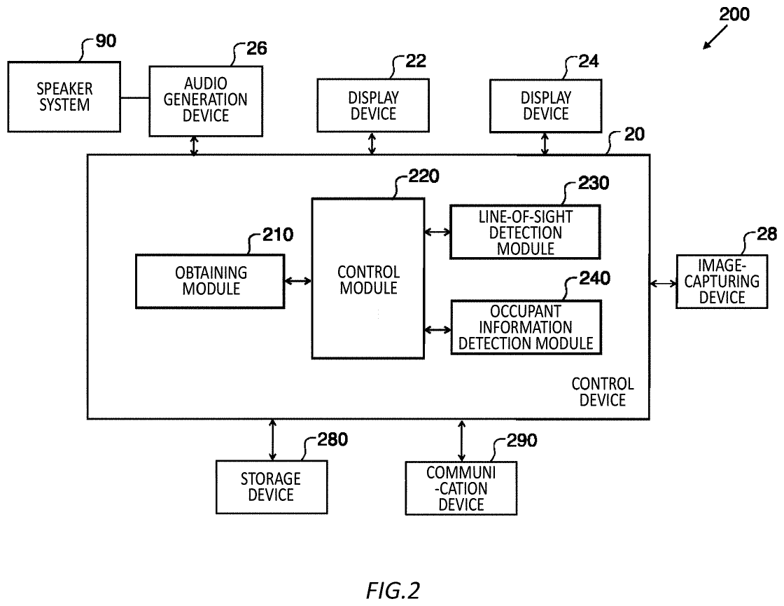

FIG. 2 shows an example of a configuration of a content viewing control system 200 included in the moving object 10. The content viewing control system 200 includes a control device 20; a display device 22 and a display device 24; an audio generation device 26; a speaker system 90; an image-capturing device 28; a storage device 280; and a communication device 290.

The speaker system 90 includes a speaker 50, a speaker 60, a speaker 70, and a speaker 80. The storage device 280 stores content. The control device 20 causes the display device 22, the display device 24, and the speaker system 90 to output content stored in the storage device 280. The storage device 280 is configured by including a non-volatile storage medium. The non-volatile storage medium may be a semiconductor memory such as a flash memory, or may be a disc storage device such as a digital versatile disc (DVD). The communication device 290 receives content from outside of the moving object 10 by means of wireless communication. The control device 20 causes the display device 22, the display device 24, and the speaker system 90 to output content received by the communication device 290.

The image-capturing device 28 is disposed in a position in which it is able to capture an image of the occupants sitting in the first seat 11, the second seat 12, the first seat 13, and the second seat 14. The image-capturing device 28 may include one or more image-capturing devices.

The control device 10 controls audio for the display device 22 installed on the moving object 10. The control device 20 includes an obtaining module 210, a control module 220, a line-of-sight detection module 230, and an occupant information detection module 240.

The display device 22 includes a first display mode in which content is displayed without dividing a display region, and a second display mode in which the display region is divided into a first display region 23a for a first seat 11 installed in the moving object 10 and a second display region 23b for a second seat 12 within the moving object 10 for displaying. The obtaining module 210 obtains information indicating a display mode of the display device 22. The control module 220 performs zoning of a space within the moving object 10 to output audio. The control module 220 differentiates the zoning depending on whether the display mode of the display device 22 is the first display mode or the second display mode.

The control module 220, when the display mode of the display device 22 is the first display mode, performs zoning of a space within the moving object 10 into one zone, and, when the display mode of the display device 22 is the second display mode, performs zoning of the space within the moving object 10 into a first zone corresponding to a position in which the first seat 11 is installed and a second zone corresponding to a position in which the second seat 12 is installed.

The control module 220, when the display mode of the display device 22 is the second display mode, controls to output audio such that audio of the first content displayed on the first display region 23a is able to be heard by an occupant located within the first zone, and controls to output audio such that audio of the second content displayed on the second display region 23b is able to be heard by an occupant located within the second zone.

The line-of-sight detection module 230 detects a line of sight of the occupant of the moving object 10. For example, the line-of-sight detection module 230, based on an image of the face of the occupant captured by the image-capturing device 280, detects the line of sight of the occupant of the moving object 10. The control module 220, when the display mode of the display device 22 is the second display mode, may control to output, to the first zone, audio of content displayed in the region located within the first zone of the first display region 23a and the second display region 23b, to which the line of sight of a first occupant extends. The control module 220 may control to output, to the second zone, audio of content displayed on the region located within the second zone of the first display region 23a and the second display region 23b, to which the line of sight of a second occupant extends.

The occupant information detection module 240 detects at least one of the state or the attribute of an occupant of the moving object 10. The state of the occupant of the moving object 10 may include the state indicating whether the occupant is asleep or not. The attribute of the occupant of moving object 10 may be, for example, the age group of the occupant of the moving object 10. The control module 220, based on at least one of the state or the attribute of the occupant detected by the occupant information detection module, further identifies an occupant who does not require audio to be output, and controls to suppress the audio to be output to a zone in which the identified occupant located.

In the above, the case is described where the control device 20 controls audio of content displayed on the display device 22 for back seats, although similar control may be applied to the case where audio of content displayed on the display device 24 for front seats is controlled. Now, As a configuration specific to the front seats, the control based on a line of sight of a driver is particularly described. In the present embodiment, let the first seat 13 be the seat in which a driver of the moving object 10 sits. And, let a first occupant be the occupant sitting in the first seat 13.

When the display mode of the display device 24 is the second display mode, the line of sight of the first occupant extends to the second display region 25b, and the first seat 13 is the seat in which the driver of the moving object 10 sits, then the control module 220 determines, depending on a driving state of the moving object 10, whether to output audio of the second content displayed on the second display region 25b to the first zone or not.

When the first seat 13 is the seat in which the driver of the moving object 10 sits, the display mode of the display device 24 is the second display mode, and the line of sight of the first occupant extends to the second display region 25b, subject to that the moving object 10 is in the stopped state or the moving object 10 is in automated driving, then the control module 220 determines to output audio of the second content to the first zone. On the other hand, when the first seat 11 is the seat in which the driver of the moving object 10 sits, the display mode of the display device 24 is the second display mode, and the line of sight of the first occupant extends to the second display region 25b, subject to that the occupant sitting in the first seat 13 is driving the moving object 10, then the control module 220 determines not to output audio of the second content to the first zone.

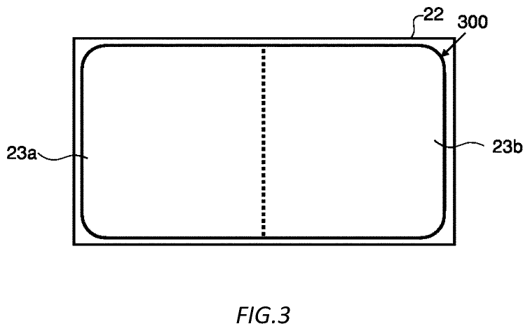

FIG. 3 schematically shows a display region of a display device 22. The entire display region 300 of the display device 22 includes a first display region 23a and a second display region 23b. The first display region 23a is a display region on the left side of the forward-moving direction of the moving object 10, and the second display region 23b is a display region on the right side of the forward-moving direction of the moving object 10. When the display mode of the display device 22 is the first display mode, the display device 22 displays single content on the entire display region 300. When the display mode of the display device 22 is the second display mode, the display device 22 displays first content on the first display region 23a, and, at the same time, displays second content different from the first content on the second display region 23b.

Similar to the display device 22, the entire display region of the display device 24 includes a first display region 25a on the left side of the forward-moving direction and a second display region 25b on the right side of the forward-moving direction. The arrangement of the first display region 25a and the second display region 25b of the display device 24 is similar to the arrangement of the first display region 23a and the second display region 23b in the display device 22, so the illustration is omitted. When the display mode of the display device 24 is the first display mode, the display device 24 displays single content on the entire display region of the display device 24. When the display mode of the display device 24 is the second display mode, the display device 24 displays first content on the first display region 25a on the left side of the forward-moving direction, and, at the same time, displays second content different from the first content on the second display region 25b on the right side of the forward-moving direction.

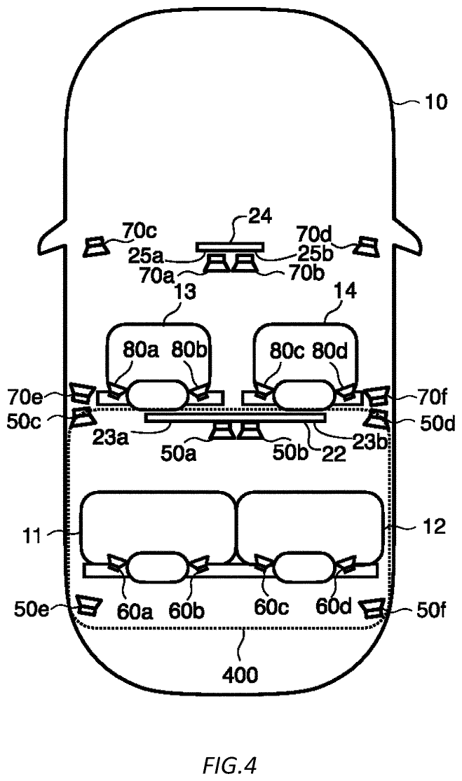

FIG. 4 schematically shows a zone 400 when the display mode of the display device 22 is the first display mode. The zone 400 is set so as to at least include a back seat area including the first seat 11 and the second seat 12. When the display mode of the display device 22 is the first display mode, the control module 220, based on audio content data of content displayed on the display region of the display device 22, causes the audio generation device 26 to generate an audio signal to be output to the speaker 50. This provides audio content of content displayed on the display region of the display device 22 through the speaker 50 to the zone 400. Therefore, the occupant sitting in the first seat 11 and the occupant sitting in the second seat 12 can view content displayed on the display region of the display device 22.

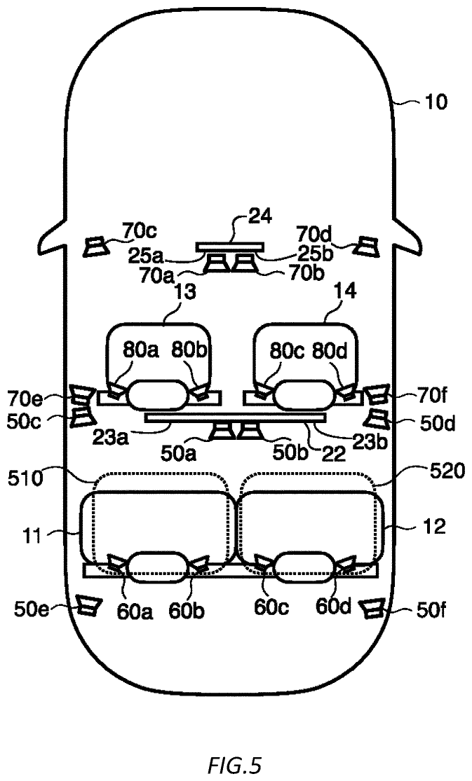

FIG. 5 schematically shows the first zone 510 and the second zone 520 when the display mode of the display device 22 is switched to the second display mode. The first zone 510 is set so as to at least include the vicinity of the headrest of the first seat 11, and the second zone 520 is set so as to at least include the vicinity of the headrest of the second seat 12.

When the display mode of the display device 22 is the second display mode, the control module 220, based on first audio content data of first content displayed on the display region 23a of the display device 22, causes the audio generation device 26 to generate an audio signal to be output to the speaker 60a and the speaker 60b, and, based on second audio content data of second content displayed on the display region 23b of the display device 22, causes the audio generation device 26 to generate an audio signal to be output to the speaker 60c and the speaker 60d. The control module 220 controls the audio generation device 26 to cause the speaker 60a and the speaker 60b to output a sound wave based on first audio content data, as well as a sound wave having the opposite phase to a sound wave based on the second audio content data output from the speaker 60c and the speaker 60d. This allows the first zone 510 to be substantially provided with only audio content of the first content displayed on the display region 23a of the display device 22 through the speaker 60a and the speaker 60b, and not to be substantially provided with audio content of the second content. On the contrary, this allows the second zone 520 to be substantially provided with only audio content of the second content displayed on the display region 23b of the display device 22 through the speaker 60c and the speaker 60d, and not to be substantially provided with audio content of the first content. Therefore, the occupant sitting in the first seat 11 and the occupant sitting in the second seat 12 can view mutually different contents.

The line-of-sight detection module 230 detects the line of sight of the occupant from an image of the face of the occupant sitting in the first seat 11 captured by the image-capturing device 28. For example, the line-of-sight detection module 230 may identify the orientation of the face of the occupant and the position of their iris from the image of the face of the occupant, and, based on the identified orientation of the face of the occupant and the position of their iris, detect the line of sight of the occupant. The control module 220 determines whether the line of sight of the occupant sitting in the first seat 11 is oriented to the first display region 23a or the second display region 23b. When the control module 220 determines that the line of sight of the occupant sitting in the first seat 11 is oriented to the second display region 23b, the control module 220, based on second audio content data of second content displayed on the second display region 23b, may cause the audio generation device 26 to generate an audio signal to be output to the speaker 60a and the speaker 60b. This allows the occupant sitting in the first seat 11 to listen to audio of the second content when they direct their line of sight to the second display region 23b. Similarly, when the control module 220 determines that the line of sight of the occupant sitting in the second seat 12 is oriented to the first display region 23a, the control module 220, based on first audio content data of first content displayed on the first display region 23a, may cause the audio generation device 26 to generate an audio signal to be output to the speaker 60c and the speaker 60d.

The occupant information detection module 240 detects the state and the attribute of an occupant of the moving object 10. For example, the occupant information detection module 240, based on the face of the occupant captured by the image-capturing device 28, the posture of the occupant, and the like, detects the state and the attribute of the occupant of the moving object 10. The occupant information detection module 240 may detect, as the state of the occupant, whether the occupant is asleep or not, whether the occupant is viewing the display device 22 or not, and the like. The occupant information detection module 240 may detect, as the attribute of the occupant, the age group the occupant belongs to. The control module 220, based on at least one of the state or the attribute of the occupant detected by the occupant information detection module 240, identifies the occupant who does not require audio to be output. For example, the control module 220 identifies the occupant asleep or the occupant who has not been viewing the display device 22 for a predetermined time of period or more as the occupant who does not require audio to be output. The control module 220 identifies the occupant for whom the age group equal to or less than a predetermined first age group is detected as the occupant who does not require audio to be output. The first age group may be the age group applicable to the infants. The control module 220 identifies the occupant for whom the age group equal to or more than a predetermined second age group is detected as the occupant who does not require audio to be output. The second age group may be the age group applicable to the elderly individuals. The control module 220 controls the audio generation device 26 not to output audio to a zone including the position of the identified occupant. For example, when the control module 220 determines that audio is not required to be output to the occupant sitting in the second seat 12, the control module 220 prohibits the audio generation device 26 from generating an audio signal to be output to the speaker 60c and the speaker 60d.

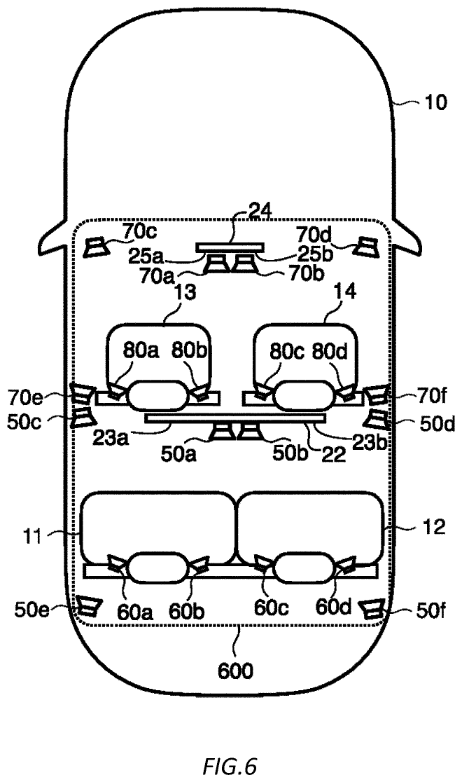

FIG. 6 schematically shows, as another aspect, a zone 600 when the display modes of the display device 22 and the display device 24 are the first display mode. The zone 600 is set when the display device 22 and the display device 24 display the same content. The zone 600 is set to the substantially entire space within the moving object 10. In this case, the control module 220, based on audio content data of content displayed on the display device 22 and the display device 24, may cause the audio generation device 26 to generate an audio signal to be output to the speaker 50 and the speaker 70. As another method, the control module 220 may cause the audio generation device 26 to output audio content of content displayed on the display device 22 and the display device 24 without using the speaker 70e and the speaker 70f. Specifically, the control module 220, based on audio content data of content displayed on the display device 22 and the display device 24, may cause the audio generation device 26 to generate an audio signal to be output from the speaker 70a, the speaker 70b, the speaker 70c, the speaker 70d, the speaker 50e, and the speaker 50f.

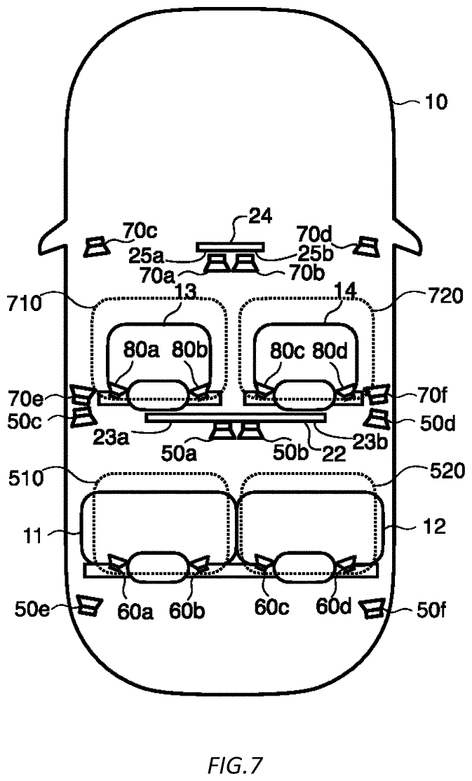

FIG. 7 schematically shows the first zone 510, the second zone 520, a first zone 710, and a second zone 720 when the display modes of the display device 22 and the display device 24 are switched to the second display mode. The first zone 510 and the second zone 520 are described in connection to FIG. 5, so the description is omitted here. Similarly, the operations of the control module 220 when the display mode of the display device 22 is the second display mode are also described in connection to FIG. 5, so the description is omitted here.

The first zone 710 is set so as to at least include the vicinity of the headrest of the first seat 13, and the second zone 720 is set so as to at least include the vicinity of the headrest of the second seat 14. When the display mode of the display device 24 is the second display mode, the control module 220, based on first audio content data of first content displayed on the display region 25a of the display device 24, causes the audio generation device 26 to generate an audio signal to be output to the speaker 80a and the speaker 80b, and, based on second audio content data of second content displayed on the display region 25b of the display device 24, causes the audio generation device 26 to generate an audio signal to be output to the speaker 80c and the speaker 80d. The control module 220 controls the audio generation device 26 to cause the speaker 80a and the speaker 80b to output a sound wave based on the first audio content data, as well as a sound wave having the opposite phase to a sound wave based on the second audio content data output from the speaker 80c and the speaker 80d. This allows the first zone 710 to be substantially provided with only audio content of the first content displayed on the display region 25a of the display device 24 through the speaker 80a and the speaker 80b, and not to be substantially provided with audio content of the second content. On the contrary, this allows the second zone 720 to be substantially provided with only audio content of the second content displayed on the display region 25b of the display device 24 through the speaker 80c and the speaker 80d, and not to be substantially provided with audio content of the first content. Therefore, the occupant sitting in the first seat 11 and the occupant sitting in the second seat 12 can view mutually different contents.

In the present embodiment, the first seat 13 is a driving seat of the moving object 10. The line-of-sight detection module 230 detects the line of sight of the occupant from an image of the face of the occupant sitting in the first seat 13 captured by the image-capturing device 28. The control module 220 determines whether the line of sight of the occupant sitting in the first seat 13 is oriented to the first display region 25a or the second display region 25b. When the control module 220 determines that the line of sight of the occupant sitting in the first seat 13 is oriented to the second display region 25b, the control module 220, subject to that the moving object 10 is stopped or the moving object 10 is driving in the automated driving mode, based on second audio content data of second content displayed on the second display region 25b, may cause the audio generation device 26 to generate an audio signal to be output to the speaker 80a and the speaker 80b. This allows the occupant sitting in the first seat 11 to, when the moving object 10 is stopped or the moving object 10 is driving in the automated driving mode, listen to audio of the second content when they direct their line of sight to the second display region 25b. Similarly, when the control module 220 determines that the line of sight of the occupant sitting in the second seat 14 is oriented to the first display region 25a, the control module 220, based on first audio content data of first content displayed on the first display region 25a, may cause the audio generation device 26 to generate an audio signal to be output to the speaker 80c and the speaker 80d.

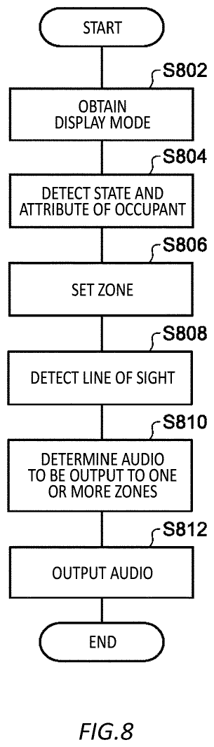

FIG. 8 shows a flowchart according to a control method performed by the control module 220. The control module 220 may repeatedly perform a process indicated in the flowchart.

In S802, the obtaining module 210 obtains a display mode of the display device 22 and the display device 24. The obtaining module 210, based on the direction of the occupant, may obtain the display mode of the display device 22 and the display device 24. The obtaining module 210 may obtain the display mode of the display device 22 and the display device 24 by obtaining information indicating the current display mode from the display device 22 and the display device 24.

In S804, the occupant information detection module 240 detects the state and the attribute of the occupant within the moving object 10. For example, the occupant information detection module 240 detects (i) whether the occupant is asleep or not, (ii) the occupant is viewing the display device 22 or not, and (iii) the age group the occupant belongs to. In S806, the control module 220, based on the display mode of the display device 22 and the display device 24, and information detected by the occupant information detection module 240, sets a zone to which audio is output. For example, the zone is set as described in connection to FIG. 4, FIG. 5, FIG. 6, FIG. 7, and the like.

In S808, the line-of-sight detection module 230 detects a line of sight of the occupant within the moving object 10. In S810, the control module 220, based on the line of sight of the occupant within the moving object 10 and the display mode of the display device 22 and the display device 24, determines audio to be output to one or more zones. In S812, the control module 220 controls to output audio determined in S810 to one or more zones. For example, the control module 220 causes the audio generation device 26 to generate an audio signal to be output to the speaker 50, the speaker 60, the speaker 70, and the speaker 80 such that the audio determined in S810 is output to one or more zones.

In the embodiment described above, the moving object 10 is a vehicle. However, any moving object other than the vehicle may be applied as the moving object 10.

According to the content viewing control system 200 according to the embodiments described above, for example, when a plurality of occupants sitting in the left and right seats desire to view the same content, the display mode of the display device can be set as the first display mode, and the same zone for at least the entire left and right seats can be set to provide the entire left and right seats with the same content. On the other hand, when the occupants of the left and right seats desire to view mutually different contents, the display mode of the display device can be set as the second display mode, and two zones corresponding to the left and right seats can be set to provide the occupant sitting in one of the seats with one of the audio contents and provide the occupant sitting in the other of the seats with the other of the audio contents. This allows the occupants of the moving object 10 to easily view different contents.

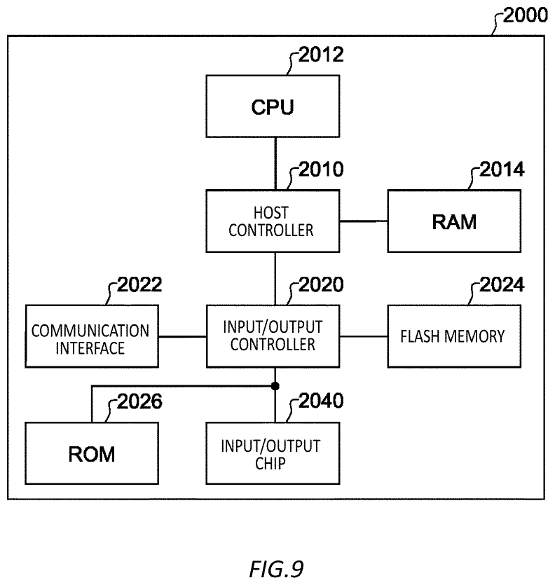

FIG. 9 shows an example of a computer 2000 where a plurality of embodiments of the present invention may be entirely or partially embodied. A program installed on the computer 2000 can cause the computer 2000 to function as the content viewing control system 200 according to the embodiments or each module of the content viewing control system 200, or an apparatus such as the control device 20 or each module of the apparatus, to perform operations associated with the system or each module of the system or the apparatus or each module of the apparatus, and/or to perform a process according to the embodiment or steps of the process. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer-readable storage medium such as a CD-ROM, a DVD-ROM, or a memory card. The RAM 2014, the ROM 2026, or the flash memory 2024 is an example of the computer-readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. An apparatus or a method may be configured by realizing operations or processing of information depending on a use of the computer 2000.

For example, when a communication is executed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgement, conditional branching, unconditional branching, information retrieval/replacement, or the like described herein and specified by instruction sequences of the programs, and write back a result into the RAM 2014. In addition, the CPU 2012 may retrieve information in a file, a database, or the like in the recording medium. For example, when multiple entries each having an attribute value of a first attribute associated with an attribute value of a second attribute, is stored in the recording medium, the CPU 2012 may retrieve an entry having a designated attribute value of the first attribute that matches a condition from these multiple entries, and read the attribute value of the second attribute stored in this entry, thereby obtaining the attribute value of the second attribute associated with the first attribute that satisfies a predetermined condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet can be used as the computer-readable storage medium. A program stored in the computer-readable storage medium may be provided to the computer 2000 via a network.

The program which is installed in the computer 2000 and causes the computer 2000 to function as the control device 20 may operate on the CPU 2012 or the like to cause the computer 2000 to function respectively as each module of the control device 20. The information processing written in these programs are read by the computer 2000 to cause the computer to function as each module of the control device 20, which is specific means realized by the cooperation of software and the various types of hardware resources described above. Thus, these specific means implement arithmetic operation or processing of information depending on a purpose of use of the computer 2000 in the present embodiment, thereby establishing the control device 20 specific to the purpose of use.

Various embodiments have been described with reference to the block diagrams and the like. In the block diagrams, each block may represent (1) a step of a process in which an operation is executed, or (2) each module of the apparatus having a role in executing the operation. A specific step and each module may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element such as a flip-flop, a register, a field programmable gate array (FPGA), a programmable logic array (PLA), or the like.

The computer-readable storage medium may include any tangible device capable of storing instructions to be executed by an appropriate device. Thereby, the computer-readable storage medium having instructions stored therein forms at least a part of a product including instructions which can be executed to provide means for executing processing procedures or operations specified in the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer-readable instruction may include an assembler instruction, an instruction-set-architecture (ISA) instruction, a machine instruction, a machine dependent instruction, a microcode, a firmware instruction, state-setting data, or either of source code or object code written in any combination of one or more programming languages including an object-oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, a special purpose computer, or another programmable data processing device, or to programmable circuit, locally or via a local area network (LAN), wide area network (WAN) such as the Internet, and a computer-readable instruction may be executed to provide means for executing operations specified in the described processing procedures or block diagrams. An example of the processor includes a computer processor, processing unit, microprocessor, digital signal processor, controller, microcontroller, or the like.

While the present invention has been described by way of the embodiments, the technical scope of the present invention is not limited to the above described embodiments. It is apparent to persons skilled in the art that various alterations or improvements can be made to the above described embodiments. It is also apparent from description of the claims that embodiments to which such alterations or improvements are made can be included in the technical scope of the present invention.

Each process of the operations, procedures, steps, and stages etc. in the apparatus, system, program, and method shown in the claims, specification, or drawings can be executed in any order as long as the order is not indicated by “prior to”, “before”, or the like and as long as the output from a previous process is not used in a later process. Even if the operational flow is described using phrases such as “first” or “next” for the sake of convenience in the claims, specification, or drawings, it does not necessarily mean that the processing must be performed in this order.

### EXPLANATION OF REFERENCES

10: moving object;
11: first seat;
12: second seat;
13: first seat;
14: second seat;
20: control device;
22: display device;
23a: first display region;
23b: second display region;
24: display device;
25a: first display region;
25b: second display region;
26: audio generation device;
28: image-capturing device;
50: speaker;
60: speaker;
70: speaker;
80: speaker;
90: speaker system;
200: content viewing control system;
210: obtaining module;
220: control module;
230: line-of-sight detection module;
240: occupant information detection module;
280: storage device;
290: communication device;
300: display region;
400: zone;
510: first zone;
520: second zone;
600: zone;
710: first zone;
720: second zone
2000: computer;
2010: host controller;
2012: CPU;
2014: RAM;
2020: Input/output controller;
2022: communication interface;
2024: flash memory;
2026: ROM;
2040: input/output chip.

What is claimed is:

1. A control device for a display device installed in a moving object, wherein
the display device comprises a first display mode in which content is displayed without dividing a display region, and a second display mode in which the display region is divided into a first display region for a first seat installed in the moving object and a second display region for a second seat within the moving object for displaying, and the control device comprises:
an obtaining module which obtains information indicating a display mode of the display device; and
a control module which performs zoning of a space within the moving object to output audio,
wherein the control module differentiates the zoning depending on whether the display mode of the display device is the first display mode or the second display mode.

2. The control device of claim 1, wherein the control module,
when the display mode of the display device is the first display mode, performs zoning of a space within the moving object into one zone, and
when the display mode of the display device is the second display mode, performs zoning of the space within the moving object into a first zone corresponding to a position in which the first seat is installed and a second zone corresponding to a position in which the second seat is installed.

3. The control device of claim 2, wherein the control module, when the display mode of the display device is the second display mode,
controls to output audio such that audio of first content displayed on the first display region is able to be heard by an occupant located within the first zone, and
controls to output audio such that audio of second content displayed on the second display region is able to be heard by an occupant located within the second zone.

4. The control device of claim 2, further comprising:
a line-of-sight detection module which detects a line of sight of an occupant of the moving object; wherein the control module, when the display mode of the display device is the second display mode,
controls to output, to the first zone, audio of content displayed on the region located within the first zone of the first display region and the second display region, to which a line of sight of a first occupant extends, and/or
controls to output, to the second zone, audio of content displayed on the region located within the second zone of the first display region and the second display region, to which a line of sight of a second occupant extends.

5. The control device of claim 4, wherein when the display mode of the display device is the second display mode, the line of sight of the first occupant extends to the second display region, and the first seat is a seat in which a driver of the moving object sits, then the control module determines, depending on a driving state of the moving object, whether to output audio of the second content displayed on the second display region to the first zone or not.

6. The control device of claim 5, wherein when the first seat is a seat in which a driver of the moving object sits, the display mode of the display device is the second display mode, and the line of sight of the first occupant extends to the second display region, subject to that the moving object is in a stopped state or the moving object is in automated driving, then the control module determines to output audio of the second content to the first zone.

7. The control device of claim 5, wherein when the first seat is a seat in which a driver of the moving object sits, the display mode of the display device is the second display mode, and the line of sight of the first occupant extends to the second display region, subject to that the first occupant is driving the moving object, then the control module determines not to output audio of the second content to the first zone.

8. The control device of claim 1, further comprising:
an occupant information detection module which detects at least one of a state or an attribute of an occupant of the moving object, wherein the control module, based on at least one of the state or the attribute of the occupant detected by the occupant information detection module, further identifies an occupant who does not require audio to be output, and controls to suppress the audio to be output to a zone in which the identified occupant located.

9. The control device of claim 6, wherein when the first seat is a seat in which a driver of the moving object sits, the display mode of the display device is the second display mode, and the line of sight of the first occupant extends to the second display region, subject to that the first occupant is driving the moving object, then the control module determines not to output audio of the second content to the first zone.

10. The control device of claim 2, further comprising:
an occupant information detection module which detects at least one of a state or an attribute of an occupant of the moving object, wherein the control module, based on at least one of the state or the attribute of the occupant detected by the occupant information detection module, further identifies an occupant who does not require audio to be output, and controls to suppress the audio to be output to a zone in which the identified occupant located.

11. The control device of claim 3, further comprising:
an occupant information detection module which detects at least one of a state or an attribute of an occupant of the moving object, wherein the control module, based on at least one of the state or the attribute of the occupant detected by the occupant information detection module, further identifies an occupant who does not require audio to be output, and controls to suppress the audio to be output to a zone in which the identified occupant located.

12. The control device of claim 4, further comprising:
an occupant information detection module which detects at least one of a state or an attribute of an occupant of the moving object, wherein the control module, based on at least one of the state or the attribute of the occupant detected by the occupant information detection module, further identifies an occupant who does not require audio to be output, and controls to suppress the audio to be output to a zone in which the identified occupant located.

13. The control device of claim 5, further comprising:
an occupant information detection module which detects at least one of a state or an attribute of an occupant of the moving object, wherein the control module, based on at least one of the state or the attribute of the occupant detected by the occupant information detection module, further identifies an occupant who does not require audio to be output, and controls to suppress the audio to be output to a zone in which the identified occupant located.

14. The control device of claim 6, further comprising:
an occupant information detection module which detects at least one of a state or an attribute of an occupant of the moving object, wherein the control module, based on at least one of the state or the attribute of the occupant detected by the occupant information detection module, further identifies an occupant who does not require audio to be output, and controls to suppress the audio to be output to a zone in which the identified occupant located.

15. The control device of claim 7, further comprising:
an occupant information detection module which detects at least one of a state or an attribute of an occupant of the moving object, wherein the control module, based on at least one of the state or the attribute of the occupant detected by the occupant information detection module, further identifies an occupant who does not require audio to be output, and controls to suppress the audio to be output to a zone in which the identified occupant located.

16. The control device of claim 1, wherein the moving object is a vehicle.

17. A content viewing control system comprising:
the control device of claim 1; and
the display device.

18. A moving object comprising the control device of claim 1.

19. A control method performed by a control device for a display device installed in a moving object, wherein
the display device comprises a first display mode in which content is displayed without dividing a display region, and a second display mode in which the display region is divided into a first display region for a first seat installed in the moving object and a second display region for a second seat within the moving object for displaying, and the control method comprises:
obtaining information indicating a display mode of the display device; and
performing zoning of a space within the moving object to output audio,
wherein the performing the zoning of the space within the moving object to output audio differentiates the zoning depending on whether the display mode of the display device is the first display mode or the second display mode.

20. A computer-readable storage medium having stored thereon a program for a display device installed in a moving object, wherein
the display device comprising a first display mode in which content is displayed without dividing a display region, and a second display mode in which the display region is divided into a first display region for a first seat installed in the moving object and a second display region for a second seat within the moving object for displaying, and the program causes a computer to function as:
an obtaining module which obtains information indicating a display mode of the display device; and
a control module which performs zoning of a space within the moving object to output audio, wherein the control module differentiates the zoning depending on whether the display mode of the display device is the first display mode or the second display mode.
